(19) United States
(12) Patent Application Publication
(10) Pub. No.: US 2005/0115988 A1
(43) Pub. Date: Jun. 2, 2005

(54) Multiple liquid foamer

(76) Inventors: Brian Law, Leicester (GB); Jeff Spencer, Leicester (GB); David Pritchett, Fort Wayne, IN (US)

Correspondence Address: Woodard, Emhardt, Moriarty, McNett & Henry LLP;Bank One Center/Tower, Suite 3700, 111 Monument Circle, Indianapolis, IN, 46204-5137, US

(21) Appl. No.: 10/725,224

(22) Filed: Dec. 1, 2003

(51) Int. Cl. B67D 5/60

(52) U.S. Cl. 222/145.5; 222/190

(57) ABSTRACT

A multiple liquid foamer includes a foamer pump that defines a pump chamber. The foamer pump includes a plunger received in the pump chamber to pump a gas. A first liquid pump is coupled to the plunger to pump a first liquid in unison with the plunger. A second liquid pump is coupled to the plunger to pump a second liquid in unison with the plunger. The foamer pump defines a liquid passage that is fluidly coupled to the first liquid pump and the second liquid pump. The liquid passage is configured to mix the first liquid from the first liquid pump and the second liquid from the second liquid pump to form a mixed liquid. The foamer pump defines a gas passage in which the gas from the pump chamber is pumped. The gas passage intersects the liquid passage to create foam with the mixed liquid and the gas.

### BACKGROUND

The present invention generally relates to fluid dispensing systems, and more specifically, but not exclusively, concerns a foamer that is able to foam liquids from at least two sources.

Some chemicals when combined have a short shelf life due to the chemical reactions caused by combining the two component chemicals. This short shelf life prevents many formulations that could provide excellent performance, because by the time the product gets to market the potency of the combination is reduced or nonexistent. One situation in which this problem arises is with a two component epoxy. Another situation can occur with cleaning supplies or personal hygiene products. It is sometimes desirable to dispense liquids in the form of foam, due to a number of attractive attributes of foam. For example, when hand soap or other types of personal cleansers are dispensed as foam, the foamed cleanser can be easily spread to cover the desired body location.

Typically, foam is created by introducing air or some other type of gas into a stream of liquid. As should be appreciated, introducing the right amount of air into the liquid to create foam can be difficult, especially with manually operated foamers. For instance, some manual foamer designs utilize what is called a foamer wall to create the foam. The foamer wall is positioned to encircle the outlet nozzle in the device. As a cone shaped spray of liquid from the nozzle hits and deflects off the foamer wall, air is introduced into the liquid, thereby creating foam. However, such foamer designs do not adequately regulate the introduction of air into the liquid such that foam may not be created, or at best, the foam created may not be uniform. Regulating the introduction of air is especially a problematic if more than one liquid is being foamed. If air introduction is not properly regulated, the resulting dispensed liquid may be insufficiently foamed and/or a foamed inconsistently. Moreover, with the liquid striking the foamer wall in such a design, the foamer's exterior can become dirty.

Thus, needs remain for further contributions in this area of technology.

### SUMMARY OF THE INVENTION

One aspect of the present invention concerns a multiple liquid foamer pump. The multiple liquid foamer includes a foamer pump that defines a pump chamber. The foamer pump includes a plunger received in the pump chamber to pump a gas. A first liquid pump is coupled to the plunger to pump a first liquid in unison with the plunger. A second liquid pump is coupled to the plunger to pump a second liquid in unison with the plunger. The foamer pump defines a mixed liquid passage that is fluidly coupled to the first liquid pump and the second liquid pump. The mixed liquid passage is constructed and arranged to mix the first liquid from the first liquid pump and the second liquid from the second liquid pump to form a mixed liquid. The foamer pump defines a gas passage in which the gas from the pump chamber is pumped. The gas passage intersects the mixed liquid passage to create foam with the mixed liquid and the gas.

Another aspect concerns an apparatus that includes a pump assembly that is constructed and arranged to couple to a container. The pump assembly includes a first liquid pump constructed and arranged to pump a first liquid from the container. A second liquid pump is disposed inside the first liquid pump to reduce the space occupied by the pump assembly in the container. The second liquid pump is constructed and arranged to pump a second liquid from the container. The pump assembly defines a mixed liquid passage that is coupled to the first liquid pump and the second liquid pump in which the first liquid and the second liquid are mixed to form a mixed liquid.

A further aspect concerns a multiple liquid foamer that includes means for manually pumping a first liquid and means for manually pumping a second liquid. The foamer further includes means for mixing the first liquid and the second liquid to form a mixed liquid. Further, the foamer includes means for manually pumping a gas into the mixed liquid in unison with the means for manually pumping the first liquid and the means for manually pumping the second liquid to create foam.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a cross sectional view, in full section, of a foamer, according to one embodiment of the present invention.

FIG. 2 is a cross sectional view, in full section, of the FIG. 1 foamer during a dispensing stroke.

FIG. 3 is an enlarged cross sectional view of a plunger in the FIG. 1 foamer during the dispensing stroke.

FIG. 4 is a cross sectional view, in full section, of a foamer, according to another embodiment of the present invention.

FIG. 5 is a cross sectional view, in full section, of the FIG. 4 foamer during a dispensing stroke.

FIG. 6 is an enlarged cross sectional view of a plunger in the FIG. 4 foamer during the dispensing stroke.

FIG. 7 is a perspective view of a piston assembly in the FIG. 4 foamer.

FIG. 8 is a cross sectional view, in full section, of a foamer, according to a further embodiment of the present invention.

FIG. 9 is a cross sectional view, in full section, of the FIG. 8 foamer during a dispensing stroke.

FIG. 10 is an enlarged cross sectional view of a plunger in the FIG. 8 foamer during the dispensing stroke.

FIG. 11 is a cross sectional view, in full section, of a foamer, according to another embodiment of the present invention.

FIG. 12 is a cross sectional view, in full section, of the FIG. 11 foamer during a dispensing stroke.

FIG. 13 is an enlarged cross sectional view of a plunger in the FIG. 11 foamer during the dispensing stroke.

FIG. 14 is a cross sectional view, in full section, of an inverted foamer, according to a further embodiment of the present invention.

FIG. 15 is an enlarged cross sectional view of a plunger in the FIG. 14 foamer during the dispensing stroke.

FIG. 16 is an enlarged cross sectional view of the FIG. 15 plunger during a return stroke.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. A number embodiments of the invention are shown in great detail, although it will be apparent to those skilled in the art that some features that are not relevant to the present invention may not be shown for the sake of clarity.

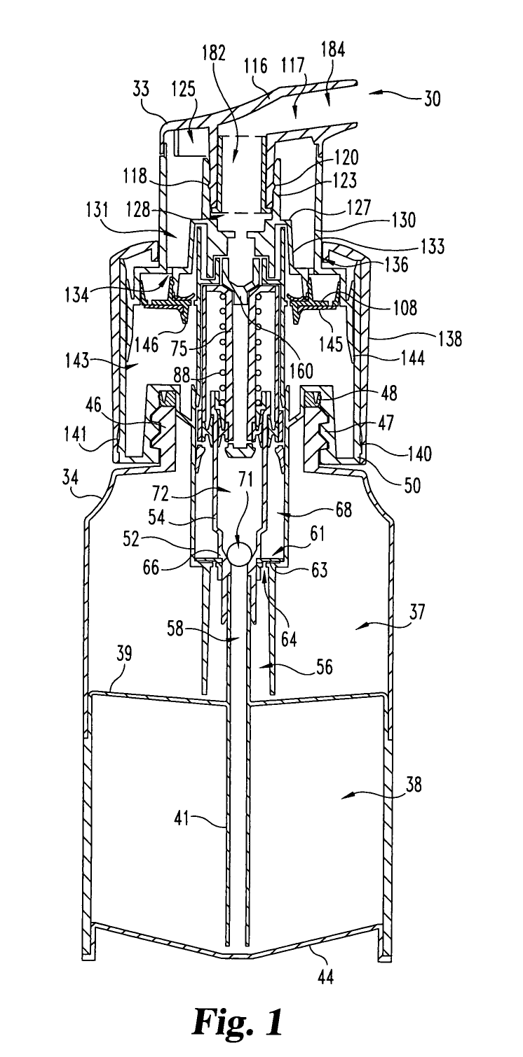

A multiple liquid foamer 30 according to one embodiment of the present invention will now be described with reference to FIGS. 1, 2 and 3. Although the illustrated foamer 30 is a twin liquid foamer, that is configured to combine two separate liquids and foam the combined liquids, it is contemplated that in other embodiments the foamer 30 can be modified to foam more than two liquids. In the illustrated embodiment, the foamer 30 has a generally cylindrical shape. However, it should be appreciated that the foamer 30 in other embodiments can be shaped differently. Referring to FIG. 1, the multi-liquid foamer 30 includes a foamer pump 33 that is secured to a container 34. The container 34 has a first compartment 37 that is configured to store a first liquid and a second compartment 38 that is configured to store a second liquid. In the illustrated embodiment, the first 37 and second 38 compartments are positioned in a stacked relationship. Nevertheless, it should be appreciated that the compartments 37, 38 can be oriented in a different manner. For instance, the compartments 37, 38 can be concentrically arranged such that the second compartment 38 is located inside the first compartment 37, or vice versa. As shown, a divider wall 39 separates the first compartment 37 from the second compartment 38, and a feed tube 41 for feeding the second fluid into the foamer pump 33 extends from the second compartment 38 into the first compartment 37. Opposite the divider wall 39, the container 34 has an end wall 44. In one form, the end wall 44 is collapsible and/or moveable so that a vacuum (low pressure) is not formed inside the second compartment 38 as the second liquid is dispensed. For instance, the end wall 44 can include a follower piston that reduces the volume of the second compartment 38 as the second liquid is dispensed. The follower piston acts in a manner similar to those used in airless dispensing systems, such as in airless dispensing systems used to dispense toothpaste. As should be appreciated the container 34 can incorporate other types of mechanisms or structures for equalizing the pressure inside the container 34. By way of a non-limiting example, the container 34 can include a venting structure in order to allow outside air to fill the second compartment 38 as the second liquid is removed.

The container 34 has a neck 46 onto which the foamer pump 33 is secured. In the embodiment shown in FIG. 1, the neck 46 is threaded so as to engage threading 47 in the foamer pump 33 such that the foamer pump 33 can be secured by being screwed onto the neck 46 of the container 34. It is contemplated that in other embodiments the foamer pump 33 can be secured in other manners. At the end of the neck 46, between the neck 46 and the threading 47 in the foamer pump 33, a vent seal 48 is positioned to permit venting of the first compartment 37, while at the same time prevent leakage of the first fluid from the first compartment 37. In order to relieve the vacuum formed inside the first compartment 37 as the first fluid is dispensed, air from outside the container 34 is drawn between the neck 46 and the foamer pump 33, through the vent seal 48 and into the first compartment 37. It should be understood that the first compartment 37 as well as the rest of the container 34 can be vented in other manners.

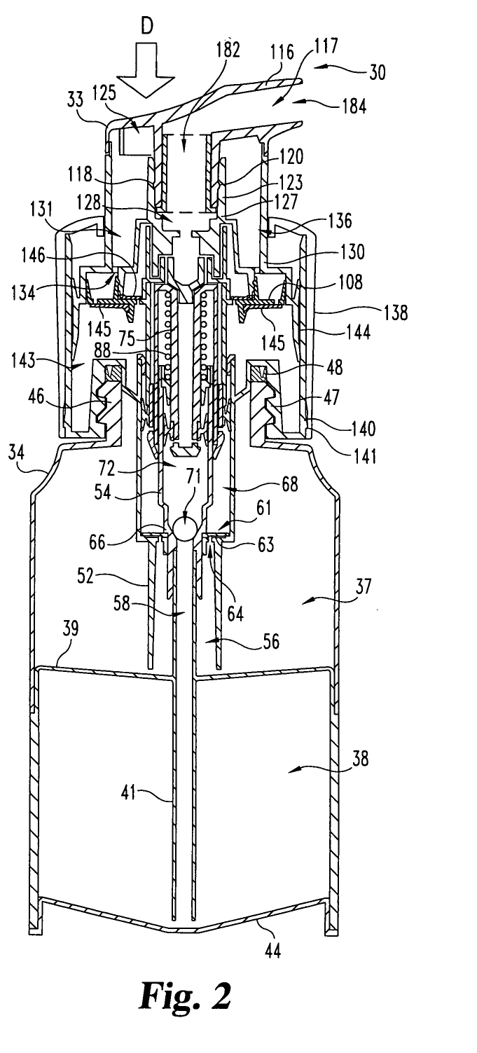

As previously mentioned, the foamer pump 33 is threadedly secured to the container 34. Referring to FIGS. 1 and 2, the foamer pump 33 has a pump body 50 that is threadedly secured to the neck 46 of the container 34. The body 50 has an outer supply tube 52 that extends through the neck 46 and into the first compartment 37. Extending inside the outer supply tube 52, an inner supply tube 54 is coupled to one end of the feed tube 41 in order to receive the second fluid from the second compartment 38. A first flow cavity 56 is formed between the outer supply tube 52 and the inner supply tube 54 as well as the feed tube 41. The feed tube 41 along with the inner supply tube 54 define a second flow cavity 58 through which the second fluid is supplied to the foamer pump 33. Inside the outer supply tube 52, a first inlet valve 61 controls the flow of the first fluid into the foamer pump 33. The first inlet valve 61 includes a first inlet valve member 63, which in the illustrated embodiment is a circular-shaped flap, that covers one or more first inlet openings 64 formed in the outer supply tube 52. A radially inner edge of the first inlet valve member 63 is sandwiched between an inlet engagement ridge 66 on the inner supply tube 54 and the outer supply tube 52. The first inlet valve 61 is configured to seal one end of a first pump chamber 68, which is formed between the outer 52 and inner 54 supply tubes, such that the first fluid is only able to flow into the first pump chamber 68. Inside the inner supply tube 54, the foamer pump 33 has a second inlet valve 71 that is configured to seal one end of a second pump chamber 72 in the inner supply tube 54. In the illustrated embodiment, the second inlet valve 71 is in the form of a ball valve that is configured to allow the second fluid to flow into the second pump chamber 72, but not back into the second compartment 38.

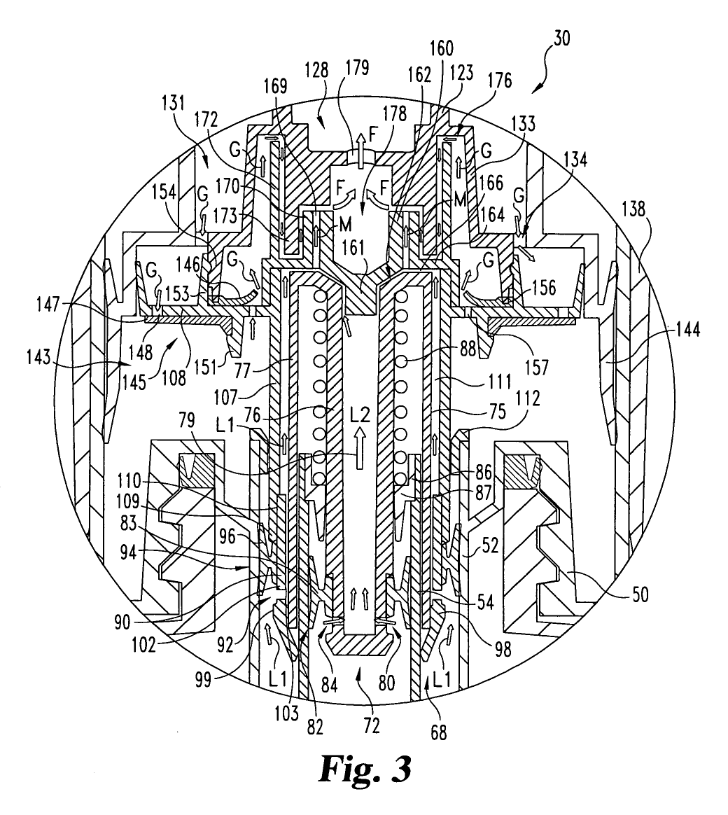

Referring to FIG. 3, a liquid piston 75 is slidably received in both the first pump chamber 68 as well as the second pump chamber 72. The liquid piston 75 includes an inner piston member 76 that is surrounded by an outer piston member 77. The inner piston member 76 defines a second fluid outlet cavity 79 with one or more second fluid outlet openings 80 through which the second fluid flows during pumping. An inner outlet valve 82 selectively opens and closes the second fluid outlet openings 80 during pumping. According to the illustrated embodiment, the inner outlet valve 82 includes an inner sliding seal 83 that is received in a seal notch 84, which is formed in the inner piston member 76 around the second fluid outlet openings 80. The inner sliding seal 83 is able to slide within the seal notch 84 so as to selectively close and open the second fluid outlet openings 80. As depicted, the inner sliding seal 83 seals between the inner piston member 76 and the inner supply tube 54. At the end of the second pump chamber 72, opposite the second inlet valve 71, the inner supply tube 54 has a retainer notch 86 in which an inner retainer 87 is received. A spring 88 presses against the inner retainer 87 in order to bias the liquid piston 75 out of the second pump chamber 72. During a pumping stroke, as the inner piston member 76 is pushed further inside the second pump chamber 72, the friction between the inner sliding seal 83 and the inner supply tube 54 causes the inner sliding seal 83 to slide along the inner piston member 76 and uncover the second fluid outlet openings 80. The spring 88 during the pumping stroke compresses, and once the foamer pump 33 is released, the spring 88 retracts the liquid piston 75. As the inner piston member 76 slides out of the second pump chamber 72, the friction between the inner sliding seal 83 and the inner supply tube 54, cause the inner sliding seal 83 to close the second fluid outlet openings 80. Once retracted, the inner retainer 87 ensures that the inner outlet valve 82 remains closed.

With continued reference to FIG. 3, a piston cap 90 engages one end of the outer piston member 77, and the piston cap 90 is configured to seal against the inner supply tube 54. As illustrated, the piston cap 90 defines one or more first fluid or outer outlet openings 92 through which the first fluid flows during pumping. An outer outlet valve 94 is configured to selectively open and close the outer outlet openings 92. In the illustrated embodiment, the outer outlet valve 94 includes an outer sliding seal 96 that is slidably received around the piston cap 90. The piston cap 90 includes an engagement portion 98 that is constructed and arranged to engage the outer piston member 77. At the engagement portion 98, the piston cap 90 has a retention ridge 99 that is configured to retain the outer sliding seal 96. Opposite engagement portion 98, the piston cap 90 has a disengaged portion 102 that is spaced away from the outer piston member 77 to form a flow cavity 103 through which the first fluid from the outer outlet opening 92 is able to flow. A portion of the liquid piston 75 is received inside a piston tube 107 of a valve plate 108. As shown in FIG. 3, one end 109 of the piston tube 107 has a cap notch 110 in which the piston cap 90 is secured, and end 109 is positioned to retain the outer sliding seal 96. The outer sliding seal 96 is able to slide between the end 109 of the piston tube 107 and the retention ridge 99 of the piston cap 90 so as to open and close the outer outlet openings 92. Between the outer piston member 77 and the piston tube 107, an outer flow channel 111 is formed through which the first fluid from the flow cavity 103 is able to flow. An outer retainer 112 that is secured to the body 50 surrounds the piston tube 107 and aids in retaining the liquid piston 75.

Referring to again to FIGS. 1 and 2, the foamer pump 33 includes a spout 116 with a spout outlet chamber 117 from which the combined, foamed liquid is dispensed. The spout 116 has a connection ridge 118 that engages a spout connection indentation 120 in a plunger 123. Proximal the spout 116, the plunger 123 has one or more air inlet notches 125 for receiving air to foam the combined liquid. Although the present invention will be described as using air to foam the combined liquid, it should be appreciated that other types of gases can be used for foaming. The plunger 123 has an inner wall portion 127 that defines a foam chamber 128 through which the foamed liquid is dispensed. The plunger 123 further has an outer wall portion 130 that, along with the inner wall portion 127, defines an air inlet cavity 131. An intermediate wall portion 133 connects the inner wall 127 to the outer wall 130, and the intermediate wall 133 has one or more air holes 134 through which air from the air inlet cavity 131 is able to pass. As shown, the plunger 123 is slidably received in a plunger opening 136 defined in a cover 138. The cover 138 is attached to the body 50 via a cover engagement ridge 140 on the body 50 that is received in a body engagement notch 141 in the cover 138. Together the plunger 123, the body 50 and the cover 138 form an air pumping chamber 143. The plunger 123 has a seal member 144 that is able to slide along a seal against the body 50.

As illustrated in FIG. 3, the valve plate 108 has air inlet 145 and outlet 146 valves that control the inflow and outflow of air from the pumping chamber 143. The air inlet valve 145 includes an air inlet seal member or flap 147 that selectively seals one or more air inlet holes 147 in the valve plate 108. The inlet flap 147 is secured to the valve plate 108 through a retention member 151. On the side opposite the retention member 151, the valve plate 108 has a plunger engagement flange 153 that secures the valve plate 108 to a valve plate engagement flange 154 on the plunger 123. The air outlet valve 146 includes an air outlet flap 156 that selectively seals one or more air outlet holes 157. According to the illustrated embodiment, the outer radial edge of the air outlet flap 156 is secured between the valve plate engagement flange 154 and the valve plate 108. During the compression stroke of the foamer pump 33, the air inlet flap 147 closes the air inlet holes 148, thereby increasing the pressure in the air pumping chamber 143. As the pressure increases, the pressure of the gas in the air pumping chamber 143 causes the outlet flap 156 to open and allow the gas to pass through gas outlet holes 157, as is shown by arrows G in FIG. 3. During the return or intake stroke of the foamer pump 33, the air outlet valve 146 closes and the air inlet valve 145 opens so as to fill the air pumping chamber 143 with air.

Between the plunger 123 and the liquid piston 75, the foamer pump 33 has an insert 160 that mixes the liquids and air to create the foam. In FIG. 3, the insert 160 has a diverter head 161, which along with the liquid plunger 75 forms a second liquid passage 162 through which the second liquid flows during dispensing, as is shown by arrows L2. The insert 160 has a valve plate engagement flange 164 that rests against the piston tube 107 of the valve plate 108 so as to form a first liquid passage 166. The first liquid passage 166 and the second liquid passage 162 meet together at a mixed liquid opening 169 defined in the insert 160. Where the first 166 and second 162 liquid passages meet, the first and second liquids mix together to form a mixed liquid that flows through the mixed liquid opening 169, as is depicted with arrows M in FIG. 3. The insert 160 has an inner diverter flange 170 and an outer diverter flange 172 that, along with an intermediate flange 173 extending from the plunger 123, form a convoluted air passage 176 that creates turbulent air flow for foaming the mixed liquid. As shown, the intermediate flange 173 is positioned between the inner 170 and outer 172 diverter flanges to form a series of ninety degree (90°) turns for creating a turbulent air flow. At the end of the convoluted air passage 176, the air or gas G blows transversely to the flow of the combined or mixed liquid M from mixed liquid opening 169 to form foamed liquid F. Specifically, the combined liquid M is impacted by the high velocity, radially flowing air, which blows at a right angle to the combined liquid. By blowing at right angles to the flow of the combined liquid, considerable turbulence is created that mixes the liquids with the air. The foamed liquid flows into a foam cavity 178 in the insert 160, through a foam aperture 179 in the plunger 123 and into the foam chamber 128. Inside the foam chamber 128, the foamer pump 33 has a mesh member 182 (FIGS. 1 and 2) with one or more mesh screens that refine the foam to a consistent form. As shown in FIGS. 1 and 2, the spout 116 has a discharge opening 184 from which the foam is dispensed.

Before dispensing the foam, the foamer pump 33 is primed by depressing the spout 116 in a dispensing or depressing direction D, as depicted in FIG. 2. As the spout 116 is depressed and the plunger 123 moves in direction D, the friction between the sliding seals 83, 96 and the supply tubes 52, 54 causes the outlet valves 82, 94 to open. While the plunger 123 moves in direction D, the spring 88 is also compressed. Once the spout 116 is released, the spring 88 expands to cause the plunger 123 to extend and return to its initial configuration, as depicted in FIG. 1. During the extension or return stroke, the friction between the sliding seals 83, 96 and the supply tubes 52, 54 causes the sliding seals 83, 96 to cover the fluid outlet openings 80, 92, thereby closing the outlet valves 82, 94. As the plunger 123 is retracted, a vacuum (low pressure) is formed in the first 68 and second 72 pump chambers, which opens the inlet valves 61, 71 to allow the first and second fluids to respectively fill the first 68 and second 72 pump chambers. At the same time, air is drawn into the air pumping chamber 143 via the air inlet valve 145. With the pump chambers 68, 72 filled with liquid, the foamer pump 33 is primed. The next time the spout 116 is depressed, the inlet valves 61, 71 for the pump chambers 68, 72 remain closed while the plunger 123 extends into the pump chambers 68, 72. During this compression stroke, the friction between the sliding seals 83, 96 and the supply tubes 52, 54 causes the outlet valves 82, 94 to open. As shown by arrows L1 in FIG. 3, the first liquid travels through the outer outlet opening 92, into flow cavity 103 and then into the outer flow channel 111. The second liquid, as depicted by arrows L2, flows through the second fluid outlet openings 80, into the second fluid outlet cavity 79, and then into the second liquid passage 162. At the mixed liquid openings 169, the first and second liquid streams combine to form a mixed fluid flow, as indicated by arrows M in FIG. 3. At the same time, the air in the air pumping chamber 143 is pressurized to cause the air outlet valve 146 to open. From the air outlet valve 146, the air travels within the convoluted passage 176, as depicted by arrows G. The now turbulent air in the convoluted passage 176 blows into the mixed fluid M from the mixed liquid openings 169 so as to form foam. As shown by arrows F, the foam travels from the foam cavity 178 into the foam chamber 128 via the foam aperture 179. In the foam chamber 128, the foam flows through the mesh member 182 to increase foam uniformity, and then the foam is dispensed out the discharge opening 184. The spout 116 can be pressed again in order to dispense more foam.

As should be appreciated, with the inner supply tube 54 positioned inside the outer supply tube 52, the volume of the foamer pump 33 occupying the container 34 is reduced, thereby allowing more fluid to be stored inside a given sized container 34. Furthermore, the above-described foamer 30 minimizes the stroke length needed to pump the foam; while at the same time provides a compact configuration. As should be appreciated, by regulating the amount of air and liquid combined in a single stroke, the foamer 30 allows consistent manual dispensing of foam with a consistent quality and uniformity.

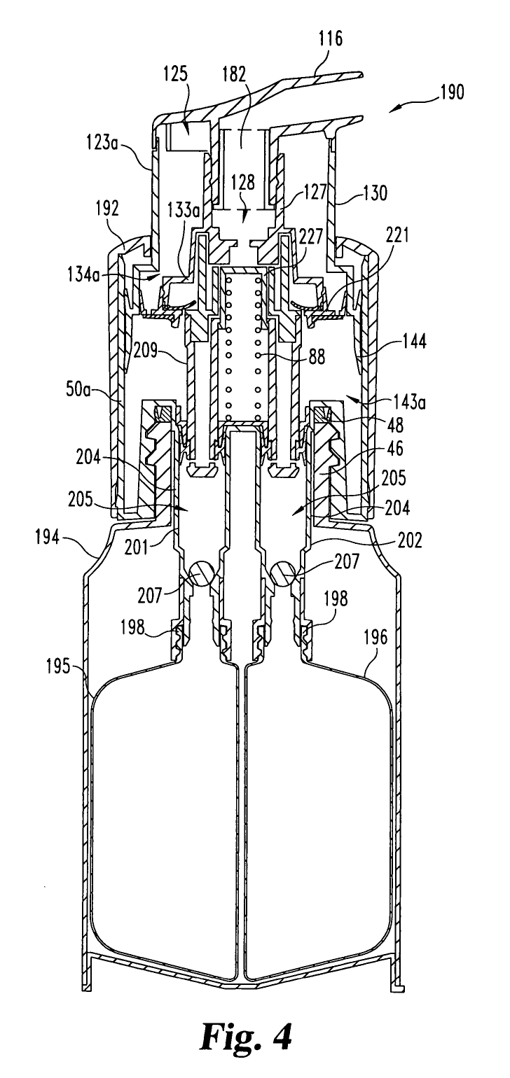

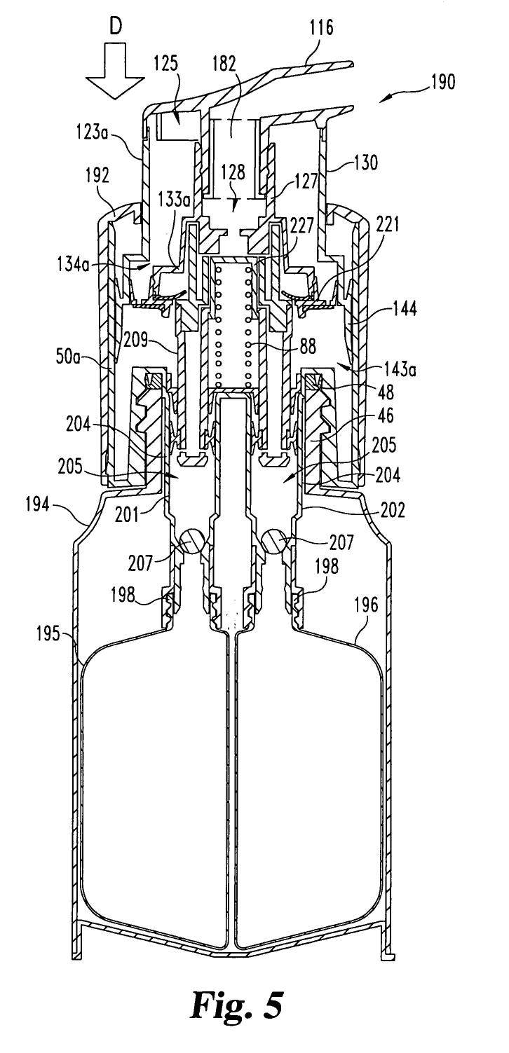

A multiple liquid foamer 190 according to another embodiment of the present invention will now be described with reference to FIGS. 4, 5, 6 and 7. The illustrated multiple liquid foamer 190 shares a number of components that are common with the previously described embodiment, and for the sake of brevity as well as clarity, these common components will not be described in great detail. Referring to FIGS. 4 and 5, the multiple liquid foamer 190 includes a foamer pump 192 that is threadedly mounted onto a container 194. Inside, the container 194 has a first bladder 195 for storing a first liquid and a second bladder 196 for storing a second liquid. Both bladders 195, 196 are deformable so that the bladders 195, 196 are able to shrink as liquid is removed. Vent seal 48 on the neck 46 of the container 194 allows air to fill the container 194 as the liquid is dispensed from the bladders 195, 196. Each bladder 195, 196 has a connector 198 that connects the bladders 195, 196 to the foamer pump 192.

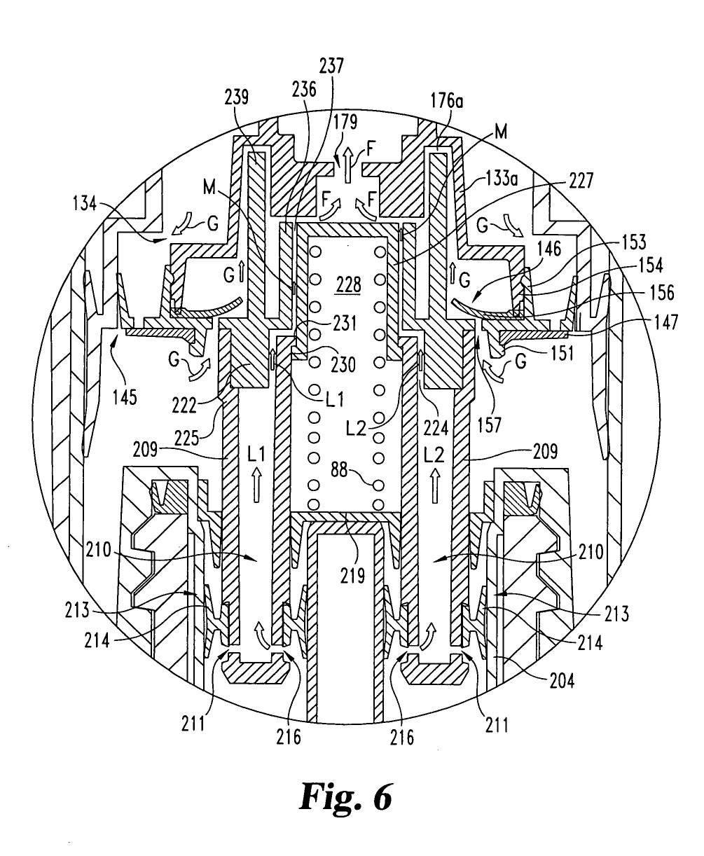

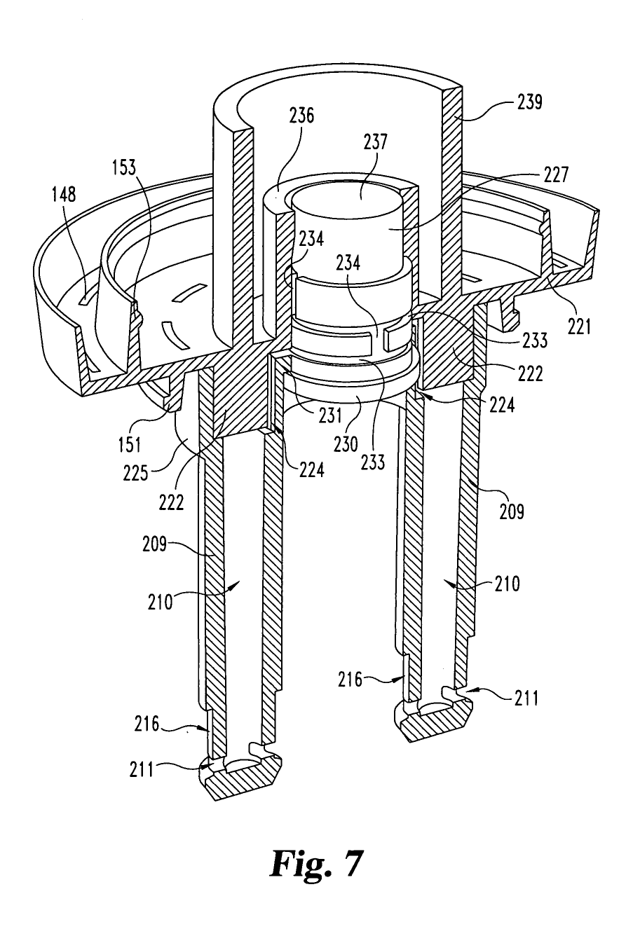

With reference to FIGS. 4 and 5, the foamer pump 192 includes side-by-side located first 201 and second 202 pump assemblies for pumping the first and second liquids from the first 195 and second 196 bladders, respectively. As shown, the first pump assembly 201 is coupled to the connector 198 of the first bladder 195, and the second pump assembly 202 is coupled to the connector 198 of the second bladder 196. Each pump assembly 201, 202 includes a pump housing or tube 204 that defines a pump cavity 205 and an inlet valve 207 that controls the inflow of liquid into the pump cavity 205. In the illustrated embodiment, the inlet valve 207 includes a ball-type check valve. As illustrated, the pair of pump tubes 204 extend from a body 50a of the foamer pump 192 that is threaded onto the container 194. Each pump assembly 201, 202 further has a piston 209 that is configured to draw liquid into and pump liquid from the pump cavity 205. As depicted in FIGS. 6 and 7, each piston 209 has a piston cavity 210 with an outlet opening 211 in which the liquid from the pump cavity 205 is received. The pistons 209 individually have an outlet valve 213 that controls the flow of liquid through the outlet opening 211. In the illustrated embodiment, the outlet valve 213 includes a sliding seal 214 that is slidably received in a slide notch 216 defined around the piston 209. In one form, the sliding seal 214 is generally ring-shaped. The slide notch 216 acts as a slide stop to control the position of the sliding seal 214. At the end of each of the piston cavities 210, a retainer 219 is secured through which the pistons 209 slide. When the pistons 209 are fully retracted, the retainer 219 ensures that the sliding seals 214 are seated so as to seal the outlet openings 211. Spring 88 presses against the retainer 219 to retract the pistons 209.

As illustrated in FIG. 7, the pistons 209 are secured to a valve plate 221. As shown, the valve plate 221 has a liquid diverter member 222 received in each piston cavity 210 that, along with the piston 209, defines a flow passage 224 into which liquid from the piston cavity 210 flows. A connector ring 225 connects the two pistons 209 together. Inside the connector ring 225, between the pistons 209, a mixer insert 227 is positioned for mixing the first and second liquids from the flow passages from the first 201 and second 202 pump assemblies, respectively. With reference to FIG. 6, the mixer insert 227 defines a spring cavity 228 in which one end of the spring 88 is received. The mixer insert 227 has a mixer flange 230 that is biased by the spring 88 against a piston flange 231 such that the connector ring 225 of the pistons 209 is pressed against the valve plate 221. Referring again to FIG. 7, the mixer insert 227 defines a series of circumferentially extending mixer channels 233 as well as longitudinally extending connector channels 234 that connect the mixer channels 233 together. As shown, successive connector channels 234 are offset radially from one another so that the liquids must first travel through the mixer channels 233 in order to promote mixing of the fluids. Extending around the mixer insert 227, the valve plate 221 has an inner diverter flange 236 that along with the mixer insert 227 defines a mixed liquid discharge passage 237 from which the mixed liquid is discharged. As will be further described below, the valve plate 221 has an outer diverter flange 239 for directing air flow that surrounds the inner diverter flange 236.

Referring again to FIGS. 4 and 5, the foamer pump 192 includes a spout 116 for discharging the foam and a plunger 123a that is connected to the spout 116. The plunger 123a is slidably received in cover 192, which is coupled to the body 50a. The plunger 123a has one or more air inlet notches 125 for receiving air or some other type of gas. Plunger 123a further includes inner wall portion 127 that defines foam chamber 128 and outer wall portion 130, which surrounds the inner wall portion 127. An intermediate wall portion 133a extends between the inner wall portion 127 and the outer wall portion 130, and the intermediate wall portion 133a has one or more air holes 134 through which air is drawn during operation of the foamer pump 192. Inside the foamer pump 192, the plunger 123a along with the valve plate 221 and the body 50a define an air pump chamber 143a. Seal member 144 on the plunger 123a seals the air pump chamber 143a by sealing against the pump body 50a.

As depicted in FIGS. 6 and 7, the valve plate 221 has air inlet 145 and outlet 146 valves that control the inflow and outflow of air from the pumping chamber 143a. The air inlet valve 145 includes an air inlet seal member or flap 147 that selectively seals one or more air inlet holes 148 in the valve plate 108. The inlet flap 147 is secured to the valve plate 221 through retention member 151. On the side opposite the retention member 151, the valve plate 221 has a plunger engagement flange 153 that secures the valve plate 221 to valve plate engagement flange 154 on the plunger 123a. The air outlet valve 146 includes an air outlet flap 156 that selectively seals one or more air outlet holes 157. According to the illustrated embodiment, the outer radial edge of the air outlet flap 156 is secured between the valve plate engagement flange 154 and the valve plate 221. During a compression stroke of the foamer pump 192, the air inlet flap 147 closes the air inlet holes 148, thereby increasing the pressure in the air pumping chamber 143a. As the pressure increases, the pressure of the gas in the air pumping chamber 143a causes the outlet flap 156 to open and allow the air to pass through air outlet holes 157, as is shown by arrows G in FIG. 6. During the return stroke of the foamer pump 192, the air outlet valve 146 closes and the air inlet valve 145 opens to fill the air pumping chamber 143a with gas.

As previously mentioned the outer diverter flange 239 on the valve plate 221 assists in directing the air flow within the foamer pump 192. The diverter flange 239 along with the plunger 123a form a convoluted air passage 176a that has a series of turns for creating a turbulent air flow. The turbulent air flow aids in improving the quality of the foam dispensed from the foamer pump 192. As depicted in FIG. 6, the convoluted air passage 176a and the mixed liquid discharge passage 237 transversely intersect so that the mixed liquid stream M combines with the gas stream G to form foam, as indicated by arrows F in FIG. 6. Specifically, the convoluted air passage 176a in the illustrated embodiment intersects the mixed liquid discharge passage 237 in a perpendicular manner so as to create turbulent air flow for foaming the combined liquid. The foam then flows through foam aperture 179 in the plunger 123a, through mesh member 182 in the spout 116 and out the spout 116.

To prime the foamer pump 192, the spout 116 in a depressed direction D, as depicted in FIG. 5, and released so that the spring 88 extends the spout 116 to its initial position, as shown in FIG. 4. As the spout 116 returns to the initial position, the pistons 209 in the first 201 and second 202 pump assemblies draw the first and second liquids from the first 195 and second 196 bladders, respectively. During this intake or return stroke, the friction between the sliding seals 214 and the pump tubes 204 cause the sliding seals 214 to cover and seal the outlet openings 211 in the pistons 209. As the plunger 123a is retracted, a vacuum (low pressure) is formed in the pump cavities 205 that draws the first and second liquids, thereby priming the foamer pump 192. At the same time, air is drawn into the air pumping chamber 143a via the air inlet valve 145.

After priming the foamer pump 192, if the spout 116 is depressed again, the inlet valves 207 for the pump cavities 205 remain closed while the plunger 123a extends back into the pump cavities 205. During this compression stroke, the friction between the sliding seals 214 and the pump tubes 204 cause the outlet valves 213 to open. As shown by arrows L1 and L2 in FIG. 6, the first and second liquids travel through the outer outlet openings 211 and into the piston cavities 210 of the first 201 and second 202 pump assemblies, respectively. Both liquids flow through their respective flow passages 224 and are mixed together in the mixer insert 227. At the same time, the air in the air pumping chamber 143a is compressed to cause the air outlet valve 146 to open. From the air outlet valve 146, the air travels within the convoluted passage 176a, as depicted by arrows G, so as to become turbulent. The now turbulent air blows into the mixed fluid M from the mixed liquid discharge passage 237 so as to create foam. As shown by arrows F, the foam travels into the foam chamber 128 via the foam aperture 179. In the foam chamber 128, the foam flows through the mesh member 182 to refine the foam, and then the foam is dispensed out the spout 116.

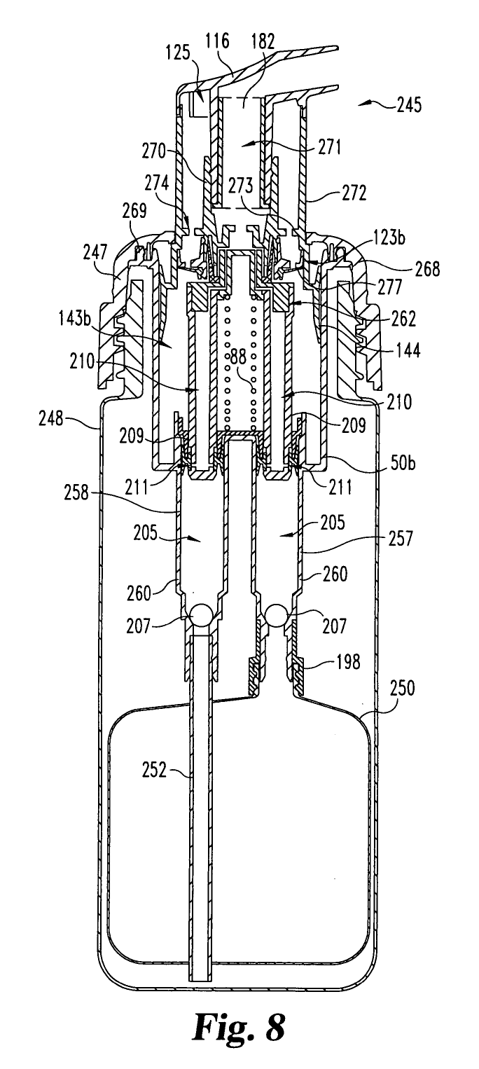

A multiple liquid foamer 245 according to a further embodiment of the present invention is illustrated in FIGS. 8, 9 and 10. As shown, the multiple liquid foamer 245 includes a foamer pump 247 that is secured to a container 248. Inside, the container 248 includes a bladder 250 with connector 198 that couples the bladder 250 to the foamer pump 247. The bladder 250 is configured to supply a first liquid to the foamer pump 247, and a second liquid is stored in the container 248 around the bladder 250. To supply the second liquid to the foamer pump 247, the container 248 has a supply tube 252 that is connected to the foamer pump 247.

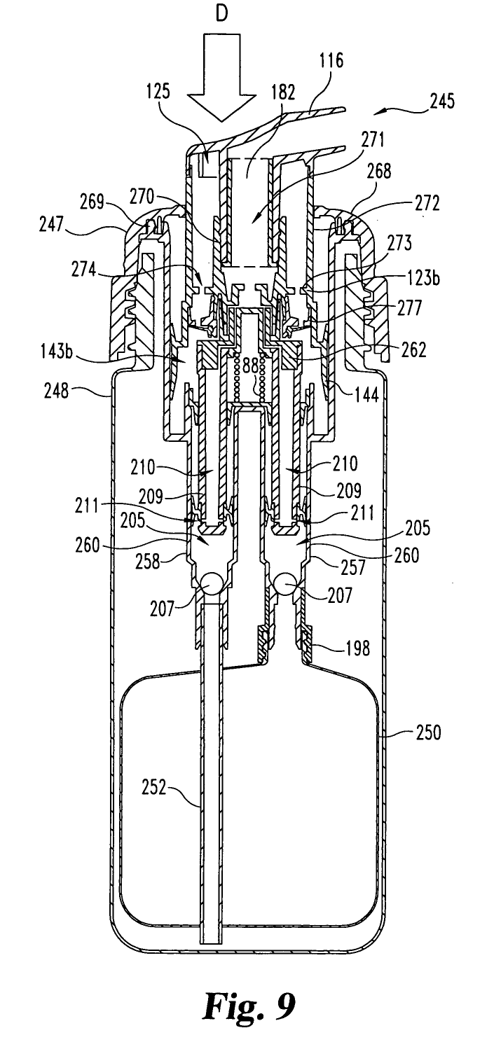

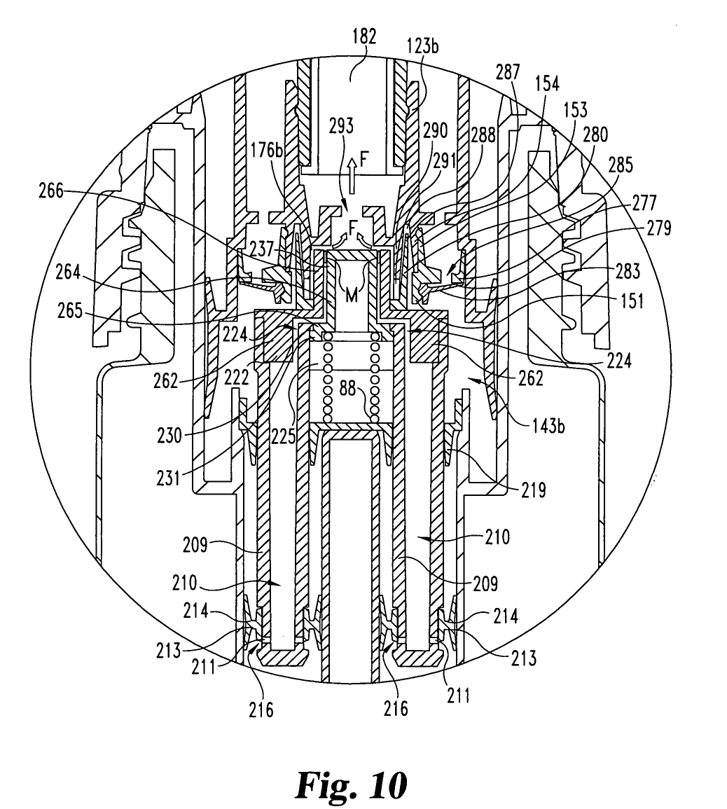

Referring to FIGS. 8 and 9, the foamer pump 247 includes side-by-side located first 257 and second 258 pump assemblies for pumping the first and second liquids, respectively. As shown, the first pump assembly 257 is coupled to the connector 198 of the bladder 250, and the second pump assembly 258 is coupled to the supply tube 252. Each pump assembly 257, 258 includes a pump housing or tube 260 that defines a pump cavity 205 and an inlet valve 207 that controls the inflow of fluid into the pump cavity 205. In the illustrated embodiment, the inlet valve 207 includes a ball-type check valve. As illustrated, the pair of pump tubes 260 extend from a body 50b of the foamer pump 192, and the pump tubes 260 are integrally formed with the body 50b in the illustrated embodiment. Each pump assembly 257, 258 further has a piston 209 that is configured to draw liquid into and pump liquid from the pump cavity 205. As depicted in FIG. 10, each piston 209 has a piston cavity 210 with one or more outlet openings 211 in which the liquid from the pump cavity 205 is received. The pistons 209 individually have an outlet valve 213 that controls the flow of liquid through the outlet opening 211. In the illustrated embodiment, the outlet valve 213 includes a sliding seal 214 that is slidably received in a slide notch 216, which is defined around the piston 209. In one form, the sliding seal 214 is generally ring-shaped, but in other embodiments of the present invention, the sliding seal 214 have a different shape. The slide notch 216 acts as a slide stop to control the position of the sliding seal 214. At the end of both piston cavities 210, a retainer 219 is secured, and the pistons 209 slide through the retainer 219. When the pistons 209 are fully retracted, the retainer 219 ensures that the sliding seals 214 are seated so as to seal the outlet openings 211. Spring 88 presses against the retainer 219 for retracting the pistons 209 to an initial, extended state.

As illustrated in FIG. 10, the pistons 209 are coupled to a piston insert 262. As shown, the piston insert 262 has a liquid diverter member 222 received in each piston cavity 210 that, along with the piston 209, defines flow passage 224 into which liquid from the piston cavity 210 flows. Connector ring 225 connects the two pistons 209 together. Inside the connector ring 225, between the pistons 209, a mixer insert 264 is positioned for mixing the first and second liquids from the flow passages 224 from the first 257 and second 258 pump assemblies, respectively. The mixer insert 264 is similar to the mixer insert 227 described above with reference to FIG. 7, with the exception that the mixer insert 264 in FIG. 10 includes a spring engagement flange 265 against which the spring 88 rests. The mixer insert 264 has a mixer flange 230 that is biased by the spring 88 against a piston flange 231 of the connector ring 225 such that the mixer insert 264 is pressed against the valve plate 221. Like mixer insert 227 illustrated in FIG. 7, the mixer insert 264 of FIG. 10 in one embodiment defines a series of radially extending mixer channels as well as longitudinally extending connector channels that connect the mixer channels together to promote mixing of the liquids. Extending around the mixer insert 264, the piston insert 262 has an inner diverter flange 266 that along with the mixer insert 264 defines a mixed liquid discharge passage 237 from which the mixed liquid is discharged.

As depicted in FIGS. 8 and 9, the foamer pump 247 includes a spout 116 for discharging the foam and a plunger 123b that is connected to the spout 116. The plunger 123b is slidably received in a cover 268 that is threadedly secured to the container 248. The cover 268 includes an engagement member 269 that secures the body 50b to the cover 268. In the illustrated embodiment, the engagement member 269 includes a pair of resilient ribs that secure the cover 268 to the body 50b. It should be appreciated that the cover 268 and body 50b can be secured in other manners. The plunger 123b has one or more air inlet notches 125 for receiving air or some other type of gas. Plunger 123b further includes inner wall portion 270 that defines foam chamber 271 and outer wall portion 272, which surrounds the inner wall portion 271. An intermediate wall portion 273 extends between the inner wall portion 271 and the outer wall portion 272, and the intermediate wall portion 273 has one or more air holes 274 through which air is drawn during operation of the foamer pump 247. To control the air flow into the foamer pump 247, the foamer pump 247 has a valve plate 277. Inside the foamer pump 247, the plunger 123b along with the valve plate 277 and the body 50b define an air pump chamber 143b. Seal member 144 on the plunger 123b seals the air pump chamber 143b by sealing against the pump body 50b.

The valve plate 277 in FIG. 10 is generally cylindrical in shape. However, it is contemplated that the valve plate 277 can have a different overall shape in other embodiments. As shown, the valve plate 277 has an air inlet valve 279 and an air outlet valve 280 that control the inflow and outflow of air from the pumping chamber 143b. The air inlet valve 279 includes an air inlet seal member or flap 283 that selectively seals an air inlet hole 285 in the valve plate 221. The inlet flap 283 is secured to the valve plate 277 through retention member 151. On the side opposite the retention member 151, the valve plate 277 has a plunger engagement flange 153 that secures the valve plate 277 to a valve plate engagement flange 154 on the plunger 123b. The air outlet valve 280 includes an air outlet flap 287 that extends inside an outlet flap groove 288 in the plunger 123b. Normally, the air outlet flap 287 seals against the valve plate engagement flange 153. During the compression stroke of the foamer pump 247, the pressure formed in the air pump chamber 143b causes the air outlet flap 287 to deflect away from the valve plate engagement flange 153, thereby allowing air to flow around the air outlet flap 287 in the outlet flap groove 288. The abrupt turn of the air flow in the outlet flap groove 288 creates turbulence in the air flow. During the return stroke of the foamer pump 247, the air outlet flap 287 closes and the air inlet valve 279 opens to fill the air pumping chamber 143b with air. An outlet valve engagement flange 290 extends from the plunger 123b to secure the air outlet flap 287 against the piston insert 262, and in part, defines the outlet flap groove 288. The valve engagement flange 290 defines an air flow notch 291 through which air flows during the compression stroke.

As shown, a convoluted passage 176b is defined between the inner diverter flange 266 of the piston insert 262 and valve engagement flange 290. Air is discharged from the air flow notch 291 via the convoluted passage 176b. The convoluted air passage 176b has a series of ninety degree (90°) turns for creating a turbulent air flow. As previously mentioned, the turbulent air flow aids in improving the quality of the foam dispensed from the foamer pump 247. To prime the foamer pump 247, the spout 116 is pressed and released, thereby drawing liquid into the first 257 and second 258 pump assemblies. When the spout 116 is pressed again after priming, the liquids travel through the piston cavities 210, and the mixed liquid M is discharge via the mixed liquid discharge passage 237. With reference to FIG. 10, the convoluted air passage 176b and the mixed liquid discharge passage 237 transversely intersect so that the mixed liquid stream M combines with the gas stream G to form foam, as indicated by arrows F in FIG. 6. The foam then flows through foam aperture 293 in the plunger 123b, through mesh member 182 in the spout 116 and out of the spout 116.

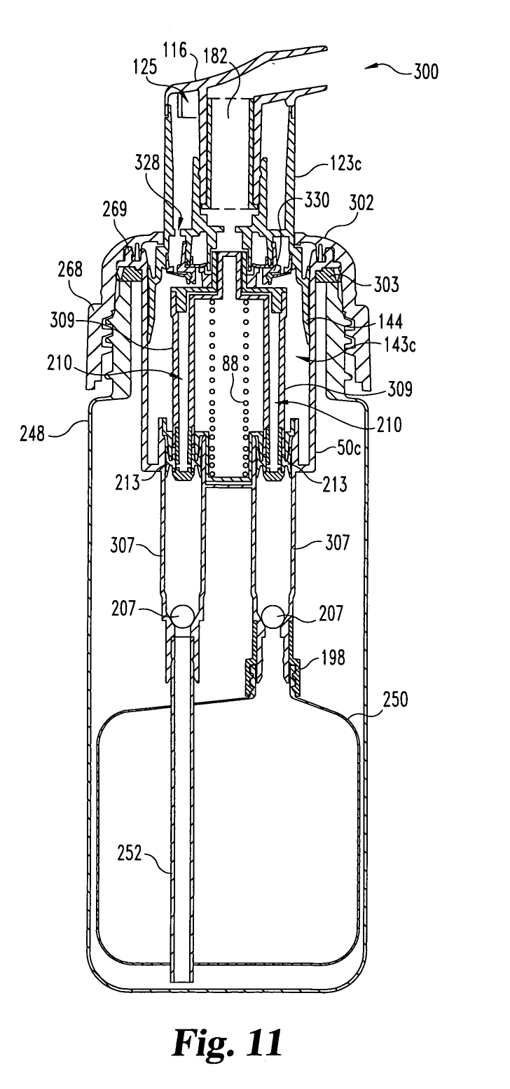

A multiple liquid foamer 300 according to a further embodiment of the present invention is illustrated in FIGS. 11, 12 and 13. As should be appreciated, the foamer 300 illustrated in FIGS. 11, 12 and 13 has a number of features that are similar to the foamer 245 illustrated in FIGS. 8, 9 and 10. For the sake of brevity and clarity, these common features will not be described in detail below, since these features were already described above. For example, like the previously described embodiment, the foamer 300 includes a container 248 with a bladder 250 as well as a connector 198 and a supply tube 252. A foamer pump 302 is threadedly secured to the container 248 with a cover 268, and the foamer pump 302 includes a spout 116 that extends from the cover 268. Cover engagement members 269 on pump body 50c secure the pump body 50c to the cover 268. Vent seal 303, which is disposed between the container 248 and the body 50c, permits air flow into the container 248, but at the same time, minimizes liquid leakage from the container 248. Plunger 123c, which is connected to the spout 116, has a seal member 144 that is slidably received in the body 50c. The plunger 123c and the body 50c define an air pumping chamber 143c into which air from an air inlet notch 125 in the plunger 123c is drawn.

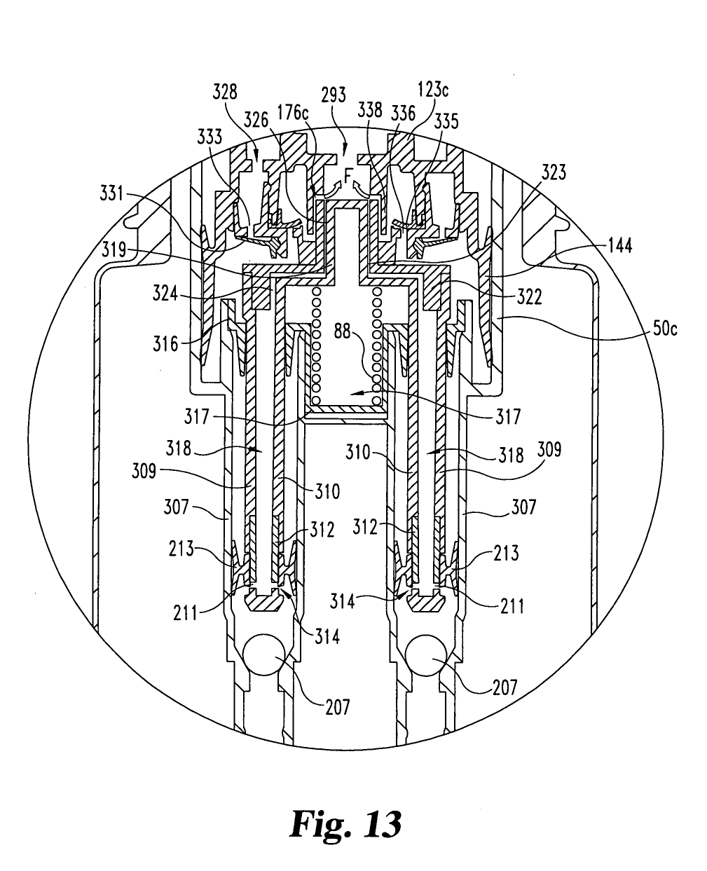

Like before, the foamer pump 302 has first 305 and second 306 pump assemblies for pumping the first liquid and the second liquid, respectively. Each pump assembly 305, 306 includes a pump tube 307 with an inlet valve 207 and a piston 309 slidably received in the pump tube 307. Around each piston 309, as illustrated in FIG. 13, an outlet valve 213 is slidably received for opening and closing one or more outlet openings 211 in the piston 309. In the illustrated embodiment, the piston 309 generally includes two main components, a piston arm 310 and a piston head 312 that is connected to the piston arm 310. As shown, the outlet openings 211 are defined in the piston head 312. Together, the piston arm 310 and the piston head 312 form a slide notch 314 in which the outlet valve 213 is slidably received. Referring to FIG. 13, the pump tubes 307 are integrally formed with the body 50c. The ends of the pump tubes 307 are closed with a retainer 316 that defines a spring cavity 317 in which the spring 88 is positioned. The pistons 309 each define a piston cavity 318 through which liquid from the outlet openings 211 flow. The pistons 309 for the first 305 and second 306 pump assemblies are joined together at a mixer insert portion 319. In order to promote mixing of the liquids, the mixer insert portion 319 in one form includes mixer channels 233 and connector channels 234 of the type illustrated for the mixer insert 227 in FIG. 7. A piston insert 322 encloses the ends of the piston cavities 318, and the piston insert 322 has an inner diverter flange 323 that, along with the pistons 309 define flow passages 224 as well as mixed liquid discharge passages 326.

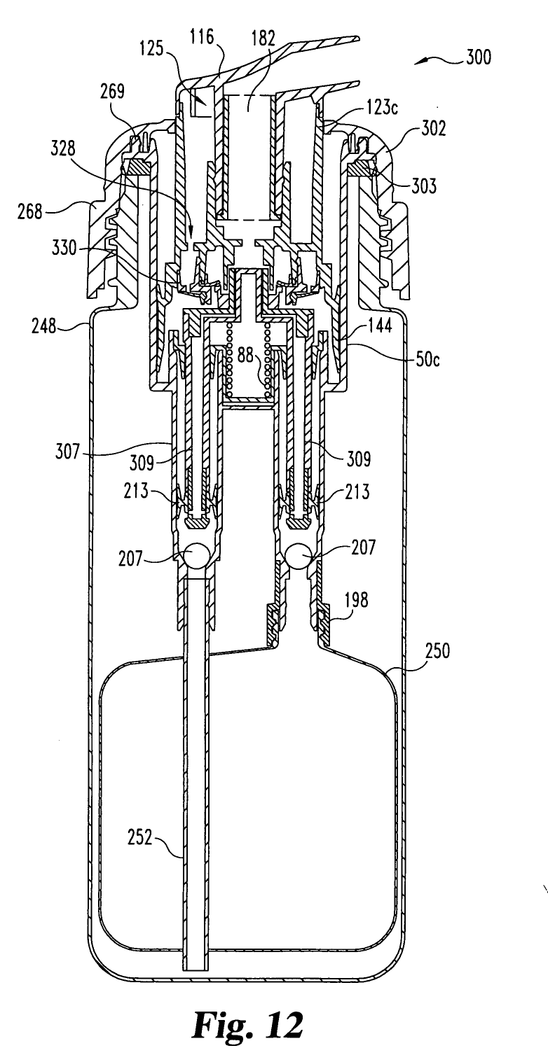

Referring to FIGS. 11 and 12, the plunger 123c has one or more air holes 328 through which air is supplied to the foamer pump 302. A valve plate 330 is coupled to the plunger to control the air flow into and out of the pumping chamber 143c. The valve plate 330, as shown in FIG. 13, includes at least one air inlet valve 331 that allows the inflow of air through one or more air inlet openings 333 in the valve plate 330, and prevents air back flow. Further, the valve plate 330 includes at least one outlet valve 335, which permits the outflow of air from one or more air outlet openings 336 in the valve plate 330.

In the illustrated embodiment, the plunger 123c has an outer diverter flange 338 that, along with the inner diverter flange 323 of the piston insert 322, defines a convoluted air passage 176c. As depicted, the convoluted passage 176c is arranged to blow the air traverse to the direction of the mixed liquid from the mixed liquid passage 326 so that foam is created. The newly formed foam is discharged out the spout 116 via the foam aperture 293 in the plunger 123c. To prime the foamer pump 302, the spout 116 is pressed and released such that the first and second liquids are drawn into the first 305 and second 306 pump assemblies, respectively. Upon pressing the spout 116 again, the outlet valves 213 open, thereby allowing the liquids flow through the piston cavities 318 and be mixed with the mixer insert portion 319. At the same time, during the compression stroke, the air from the pumping chamber 143c blows through the air outlet valve 335 and the convoluted passage 176c to create the foam. Upon releasing the spout 116, the spring 88 returns the spout 116 to its original position, which in turn draws the liquids into the pump assemblies 305, 306.

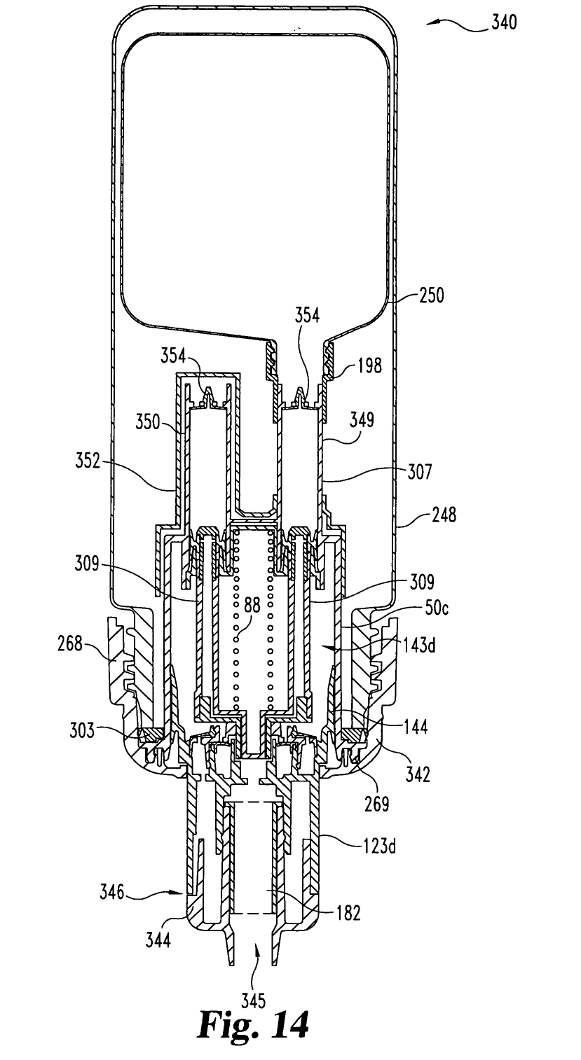

A multiple liquid inverted foamer 340, according to still yet another embodiment, will now be described with reference to FIGS. 14, 15 and 16. The inverted foamer 340 can be used to dispense many types of liquids, including liquid hand soap. As should be appreciated, many of the features of the inverted foamer 340 can be incorporated into non-inverted type foamers that are oriented differently than the one illustrated. The inverted foamer 340 includes a foamer pump 342 that is threadedly secured to a container 248. Inside, the container 248 includes a bladder 250 with a connector 198 that is coupled to the foamer pump 342. Air vent seal 303 is positioned between the container 248 and the foamer pump 342 so as to allow air to vent into the container 348, while minimizing liquid leakage from the container 248. As shown, the foamer pump 342 has a spout 344 with a spout opening 345 from which foam is dispensed. The spout 344 is coupled to a plunger 123d that is slidably received within cover 268. One or more air inlet notches 346 are formed at the interface between the spout 344 and the plunger 123d. The cover 268 is secured to pump body 50c with engagement member 269. Seal member 144 of the plunger 123d slidingly seals against the body 50c to form air pumping cavity 143d.

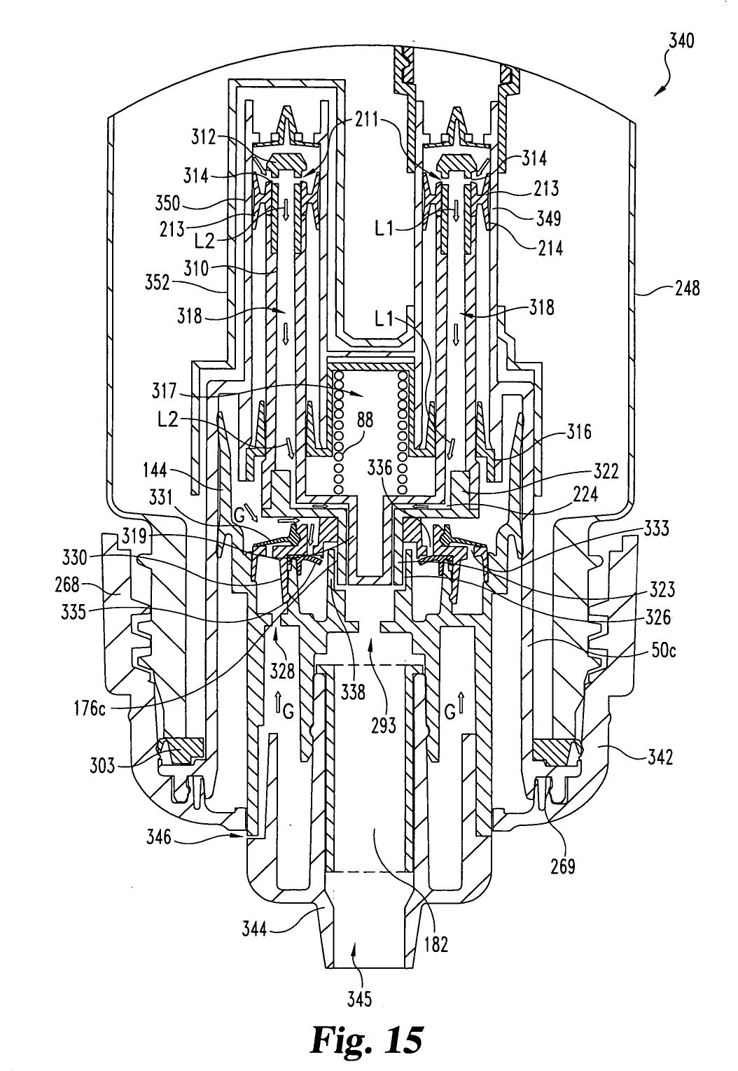

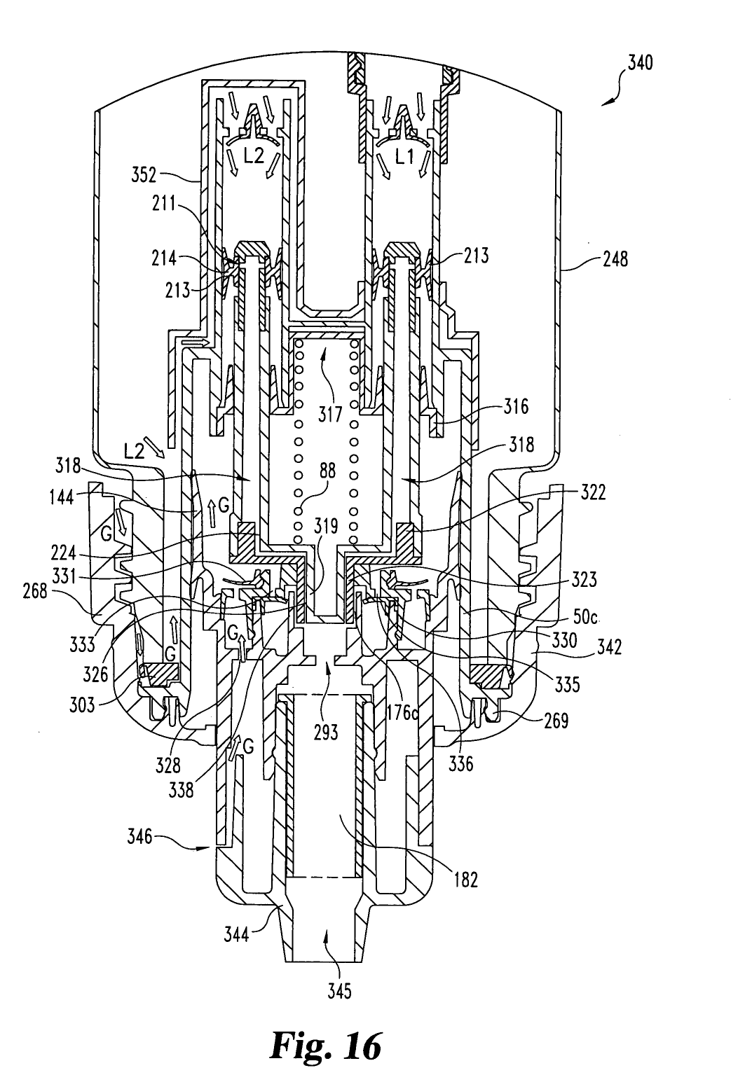

As illustrated in FIG. 14, first 349 and second 350 pump assemblies extend within the container 248. The first pump assembly 349 receives the first liquid from the bladder 250, and the second pump assembly 350 receives the second liquid from the container 248. As shown, a shroud 352 covers the second pump assembly 350, and the shroud 352 acts as a straw to draw fluid into the second pump assembly 350. Each pump assembly 349, 350 includes a pump tube 307, a piston 309 slidably received in the pump tube 307 and a liquid inlet valve 354. In the illustrated embodiment, the liquid inlet valve 354 includes an umbrella type valve. Around each piston 309, as illustrated in FIGS. 15 and 16, an outlet valve 213, which is in the form of a sliding seal 214, is slidably received for opening and closing one or more outlet openings 211 in the piston 309. According to the illustrated embodiment, the piston 309 generally includes two main components, a piston arm 310 and a piston head 312 connected to the piston arm 310. As shown, the outlet opening 211 is defined in the piston head 312. Together, the piston arm 310 and the piston head 312 form a slide notch 314 in which the outlet valve 213 is slidably received. Referring to FIG. 15, the pump tubes 307 are integrally formed with the body 50c. The ends of the pump tubes 307 are closed with a retainer 316 that defines a spring cavity 317 against which the spring 88 presses. The pistons 309 each define a piston cavity 318 through which liquid from the outlet openings 211 flow. The pistons 309 for the first 349 and second 350 pump assemblies are joined together at a mixer insert portion 319. In order to promote mixing of the liquids, the mixer insert portion 319 in one form includes mixer channels 233 and connector channels 234 of the type illustrated for the mixer insert 227 in FIG. 7. A piston insert 322 encloses the ends of the piston cavities 318, and the piston insert 322 has an inner diverter flange 323 that, along with the pistons 309 define flow passages 224 as well as mixed liquid discharge passages 326.

The plunger 123d has one or more air holes 328 through which air is supplied to the foamer pump 342. Valve plate 330 is coupled to the plunger 123d to control the air flow into and out of the pumping chamber 143d. The valve plate 330 includes at least one air inlet valve 331 that allows the inflow of air through one or more air inlet openings 333 in the valve plate 330, and prevents air back flow. Further, the valve plate 330 includes at least one outlet valve 335, which permits the outflow of air from one or more air outlet openings 336 in the valve plate 330. In the illustrated embodiment, the plunger 123d has an outer diverter flange 338 that, along with the inner diverter flange 323 of the piston insert 322, defines a convoluted air passage 176c. As depicted, the convoluted passage 176c is arranged to blow the air traverse to the direction of the mixed liquid from the mixed liquid passage 326 so that foam is created. The newly formed foam is discharged out the spout opening 345 via the foam aperture 293 in the plunger 123c. To prime the foamer pump 302, the spout 344 is pressed and released such that the first and second liquids are drawn into the first 349 and second 350 pump assemblies, respectively. Upon pressing the spout 345 again, the outlet valves 213 open, thereby allowing the liquids flow through the piston cavities 318 and be mixed with the mixer insert portion 319. At the same time, during the compression stroke, the air from the pumping chamber 143d blows through the air outlet valve 335 and the convoluted passage 176c to create the foam. Upon releasing the spout 344, the spring 88 returns the spout 344 to its original position, which in turn draws the liquids into the pump assemblies 349, 350.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A multiple liquid foamer, comprising:
a foamer pump defining a pump chamber, the foamer pump including
a plunger slidably received in the pump chamber to pump a gas,
a first liquid pump coupled to the plunger to pump a first liquid in unison with the plunger, and
a second liquid pump coupled to the plunger to pump a second liquid in unison with the plunger; and
wherein the foamer pump defines a mixed liquid passage that is fluidly coupled to the first liquid pump and the second liquid pump, the mixed liquid passage being constructed and arranged to mix the first liquid from the first liquid pump and the second liquid from the second liquid pump to form a mixed liquid;
wherein the foamer pump defines a gas passage in which the gas from the pump chamber is pumped; and
wherein the gas passage intersects the mixed liquid passage to create foam with the mixed liquid and the gas.

2. The foamer of claim 1, wherein the second liquid pump is positioned inside the first liquid pump to reduce the overall size of the foamer pump.

3. The foamer of claim 2, wherein:
the second liquid pump includes
an inner tube defining an inner piston chamber, and
an inner piston member slidably received in the inner piston chamber to pump the second liquid; and
the first liquid pump includes
an outer tube surrounding the inner tube, the outer tube and the inner tube defining an outer piston chamber, and
an outer piston member slidably received in the outer piston chamber to pump the first liquid.

4. The foamer of claim 3, wherein:
the second liquid pump includes
an inner inlet valve to permit inflow of the second liquid into the inner piston chamber, and
an inner outlet valve to permit outflow of the second liquid from the inner piston chamber; and
the first liquid pump includes
an outer inlet valve to permit inflow of the first liquid into the outer piston chamber, and
an outer outlet valve to permit outflow of the first liquid from the outer piston chamber.

5. The foamer of claim 4, wherein:
the inner piston member defines an inner outlet opening;
the inner outlet valve includes an inner sliding seal slidably received around the inner piston member to selectively open and close the inner outlet opening;
the outer piston member defines an outer outlet opening; and
the outer outlet valve includes an outer sliding seal slidably received around the outer piston member to selectively open and close the outer outlet opening.

6. The foamer of claim 5, wherein:
the second liquid pump includes an inner retainer coupled to the inner tube for closing the inner sliding seal over the inner outlet opening when the inner piston member is in a retracted position; and
the first liquid pump includes an outer retainer coupled to the outer tube for closing the outer sliding seal over the outer outlet opening when the outer piston member is in a retracted position.

7. The foamer of claim 6, further comprising a spring engaged against the inner retainer to bias the inner piston member in the retracted position.

8. The foamer of claim 2, wherein the first liquid pump and the second liquid pump are concentrically arranged.

9. The foamer of claim 2, further comprising a container coupled to the foamer pump.

10. The foamer of claim 9, wherein:
the container includes a divider wall that defines a first compartment in which the first liquid is stored and a second compartment in which the second liquid is stored;
the first compartment and the second compartment are positioned in a stacked relationship; and
the container includes a feed tube that extends from the second compartment and that is coupled to the second liquid pump to supply the second liquid.

11. The foamer of claim 1, wherein the first liquid pump and the second liquid pump extend in a side by side relationship.

12. The foamer of claim 1, further comprising a mesh member positioned in the foamer pump to refine the foam.

13. The foamer of claim 1, wherein the gas passage includes a convoluted passage with one or more turn portions to increase turbulence of the gas.

14. The foamer of claim 1, further comprising a valve plate coupled to the plunger, the valve plate including an inlet valve configured to permit inflow of the gas into the pump chamber and an outlet valve configured to permit outflow of the gas from the pump chamber.

15. The foamer of claim 1, wherein at least a portion of the mixed liquid passage is defined at least in part by a mixer insert.

16. The foamer of claim 15, wherein the mixer insert defines one or more mixer channels that circumferentially extend around the mixer insert and one or more connector channels that extend longitudinally along the mixer insert.

17. The foamer of claim 1, further comprising a spout connected to the plunger to dispense the foam.

18. The foamer of claim 1, wherein the gas passage and the mixed liquid passage transversely intersect to enhance foaming of the foam.

19. The foamer of claim 18, wherein the gas passage and the mixed liquid passage intersect in an orthogonal manner.

20. The foamer of claim 1, further comprising a container coupled to the foamer pump.

21. The foamer of claim 20, wherein:
the container includes a divider wall that defines a first compartment in which the first liquid is stored and a second compartment in which the second liquid is stored;
the first compartment and the second compartment are positioned in a stacked relationship; and
the container includes a feed tube that extends from the second compartment and that is coupled to the second liquid pump to supply the second liquid.

22. The foamer of claim 20, wherein the container includes a first bladder coupled to the first liquid pump to supply the first liquid.

23. The foamer of claim 22, wherein the container includes a second bladder coupled to the second liquid pump to supply the second liquid.

24. The foamer of claim 22, wherein the container includes a supply tube to supply the second liquid contained around the first bladder.

25. The foamer of claim 20, further comprising a vent seal positioned between foamer pump and the container to vent the container.

26. The foamer of claim 1, wherein the foamer pump includes an inverted foamer pump constructed and arranged to dispense the foam from an inverted position.

27. The foamer of claim 26, wherein the inverted foamer pump includes a shroud member covering the second liquid pump to draw the second liquid into the second liquid pump.

28. The foamer pump of claim 26, wherein the first and second liquid pumps each include an umbrella valve for controlling flow of the first and second liquids into the first and second liquid pumps.

29. The foamer pump of claim 1, wherein the first liquid pump includes a piston tube that defines a piston chamber, a piston slidably disposed in the piston chamber, an inlet valve and an outlet valve.

30. The foamer pump of claim 29, wherein inlet valve includes a ball valve disposed at one end of the piston tube.

31. The foamer pump of claim 29, wherein inlet valve includes an umbrella valve disposed at one end of the piston tube.

32. The foamer pump of claim 29, wherein the outlet valve includes an outlet opening defined in the piston and a sliding seal slidably received around the piston to open and close the outlet opening.

33. The foamer pump of claim 32, wherein the first liquid pump includes a retainer coupled to the piston tube.

34. An apparatus, comprising:
a pump assembly constructed and arranged to couple to a container, the pump assembly including
a first liquid pump constructed and arranged to pump a first liquid from the container, and
a second liquid pump disposed inside the first liquid pump to reduce space occupied by the pump assembly in the container, the second liquid pump being constructed and arranged to pump a second liquid from the container; and
wherein the pump assembly defines a mixed liquid passage coupled to the first liquid pump and the second liquid pump in which the first liquid and the second liquid are mixed to form a mixed liquid.

35. The apparatus of claim 34, wherein:
the pump assembly defines a pump chamber;
the pump assembly includes a plunger received in the pump chamber to pump gas from the pump chamber; and
the pump assembly defines a passage in which the mixed liquid and the gas are combined to form foam.

36. A multiple liquid foamer, comprising:
means for manually pumping a first liquid;
means for manually pumping a second liquid;
means for mixing the first liquid and the second liquid to form a mixed liquid; and
means for manually pumping a gas into the mixed liquid in unison with said means for manually pumping the first liquid and said means for manually pumping the second liquid to create foam.
